(19) United States
(12) Patent Application Publication
(10) Pub. No.: US 2013/0142966 A1
(43) Pub. Date: Jun. 6, 2013

(54) BLUE PHOTOSENSITIVE RESIN COMPOSITION FOR COLOR FILTERS AND USES THEREOF

(71) Applicant: CHI MEI CORPORATION, Tainan City (TW)

(72) Inventors: BAR-YUAN HSIEH, TAINAN CITY (TW); JUNG-PIN HSU, TAINAN CITY (TW); BO-HSUAN LIN, TAINAN CITY (TW); CHUN-AN SHIH, TAINAN CITY (TW); MING-JU WU, TAINAN CITY (TW)

(73) Assignee: CHI MEI CORPORATION, TAINAN CITY (TW)

(21) Appl. No.: 13/681,864

(22) Filed: Nov. 20, 2012

(30) Foreign Application Priority Data
Dec. 5, 2011 (TW) 100144671

(51) Int. Cl. G02B 5/23

(52) U.S. Cl. CPC G02B 5/23
USPC 428/1.31; 430/281.1; 430/7; 428/156

(57) ABSTRACT

The invention relates to a blue photosensitive resin composition, and the smoothness of the edge profile formed thereby after development is good. Furthermore, the contrast of a liquid crystal display device manufactured with the blue photosensitive resin composition is excellent. The invention also provides a method for manufacturing a color filter, a color filter and a liquid crystal display device are also provided in the invention.

### BACKGROUND OF THE INVENTION

1. Field of the Invention

The invention relates to a blue photosensitive resin composition. Particularly, and the smoothness of the edge profile formed with the blue photosensitive resin composition after development is good and the contrast of a liquid crystal display device manufactured with the blue photosensitive resin composition is excellent.

2. Description of the Related Art

In the manufacturing process of a color filter, the use of the photosensitive resin is an important step. The conventional method of manufacturing a color filter is forming the photosensitive resin composition on a transparent substrate. The composition is dried through a pre-bake step, and further subjected to a light exposure, development and post-bake steps, and then colored pixels and a black matrix are obtained. Examples of the methods are disclosed in Japanese Patent Publication Nos. 2-144502 and 3-53201 providing a method of manufacture of colored pixels, Japanese Patent Publication No. 6-35188 providing a method for manufacturing a black matrix using a photopolymerizable composition that contains a black material.

Recently, because of its light, thin, power-saving features, the liquid crystal display device is rapidly developed in a variety of electronic appliances, such as televisions. However, in this application, high-contrast is a general requirement. In order to enhance the characteristics of the liquid crystal display device with high contrast, skilled artisans in this field had developed a photosensitive resin composition to enhance the contrast of the color. For example, Japanese Patent Publication No. 2001-033616 discloses a blue photosensitive resin composition for a color filter comprising a specific pigment C. I. Pigment Red 122. However, the liquid crystal display device manufactured with the above method has been failed to meet the ever-increasing demand of contrast in the modern field.

Moreover, the evolution of the modern liquid crystal displays are toward the direction of the high-resolution, and the increase of pixel fineness is an important improvement target. In order to achieve the high pixel fineness, the edge of the pixel pattern must be smooth. However, applying these conventional photosensitive resin in manufacturing a filter, the edge smoothness is poor when coating the photosensitive resin on an inorganic film of a transparent conductive film (such as indium tin oxide, IZO, etc.) or a silicon nitride and silicon oxide film. This shortcoming would cause cracks or faults in the pixel layer.

Therefore, enhancing the smoothness of the pixel pattern edges and the contrast of the liquid crystal display device at the same time to meet the modern requirements is a target remained to be achieved in the technical field of the present invention.

### SUMMARY OF THE INVENTION

In the present invention, the specific contents of an alkali-soluble resin is provided to obtain a photosensitive resin composition which the smoothness of the edge profile formed with after development is good, and the contrast of a liquid crystal display device manufactured with is excellent.

Therefore, the invention relates to a photosensitive resin composition comprising:
an alkali-soluble resin (A);
a compound having an ethylenically unsaturated group (B);
a photoinitiator (C);
an organic solvent (D);
a pigment (E); and
a dye (F);
wherein the alkali-soluble resin (A) comprises a polysiloxane (A-1), and the polysiloxane (A-1) is obtained by hydrolyzing and condensing a silane compound represented by Formula (1);

Si(R^{a})_{z}(OR^{b})_{4-z} Formula (1)
wherein:
at least one of R^{a} represents an alkyl group having a carboxylic acid anhydride sub stituent; and the other R^{a} is independently selected from the group consisting of a hydrogen atom, a C₁-C₁₀ alkyl group, a C₂-C₁₀ alkenyl group, and a C₆-C₁₅ aryl group;
R^{b} is independently selected from the group consisting of a hydrogen atom, a C₁-C₆ alkyl group, a C₁-C₆ acyl group, and a C₆-C₁₅ aryl group; and
z represents an integer from 1 to 3.

The present invention also provides a method for manufacturing a color filter comprising forming a pattern with the photosensitive resin composition as mentioned above.

The present invention also provides a color filter manufactured by the method as mentioned above.

The present invention further provides a liquid crystal display device comprising the color filter as mentioned above.

### BRIEF DESCRIPTION OF THE DRAWINGS

FIG. 1 shows the schematic diagram of the color liquid crystal display in a preferred embodiment of the invention;

FIG. 2 is a schematic diagram of a state (a) of the determination of contrast of the photosensitive resin layer;

FIG. 3 is a schematic diagram of a state (b) of the determination of contrast of the photosensitive resin layer;

FIG. 4 is a edge profile of a state (a) of the photosensitive resin layer pattern;

FIG. 5 is a edge profile of a state (b) of the photosensitive resin layer pattern; and

FIG. 6 is a edge profile of a state (c) of the photosensitive resin layer pattern.

### DETAILED DESCRIPTION OF THE INVENTION

The invention relates to a photosensitive resin composition comprising:
an alkali-soluble resin (A);
a compound having an ethylenically unsaturated group (B);
a photoinitiator (C);
an organic solvent (D);
a pigment (E); and
a dye (F);
wherein the alkali-soluble resin (A) comprises a polysiloxane (A-1), and the polysiloxane (A-1) is obtained by hydrolyzing and condensing a silane compound represented by Formula (1);

Si(R^{a})_{z}(OR^{b})_{4-z} Formula (1)
wherein:
at least one of R^{a} represents an alkyl group having a carboxylic acid anhydride sub stituent; and the other R^{a} is independently selected from the group consisting of a hydrogen atom, a C₁-C₁₀ alkyl group, a C₂-C₁₀ alkenyl group, and a C₆-C₁₅ aryl group;
R^{b} is independently selected from the group consisting of a hydrogen atom, a C₁-C₆ alkyl group, a C₁-C₆ acyl group, and a C₆-C₁₅ aryl group; and
z represents an integer from 1 to 3.

The alkali-soluble resin (A) according to the invention comprises a polysiloxane (A-1). There is no specific limitation to the structure of polysiloxane (A-1). In one preferred embodiment of the invention, the polysiloxane (A-1) is obtained by hydrolyzing and condensing a silane compound and/or a siloxane prepolymer; preferably, by partially condensing.

In one preferred embodiment of the invention, the silane compound includes but is not limited to a structure represented by Formula (1);

Si(R^{a})_{z}(OR^{b})_{4-z} Formula (1)
wherein:
at least one of R^{a} represents an alkyl group having a carboxylic acid anhydride sub stituent; and the other R^{a} is independently selected from the group consisting of a hydrogen atom, a C₁-C₁₀ alkyl group, a C₂-C₁₀ alkenyl group, and a C₆-C₁₅ aryl group. The plural R^{a}s can be identical with or different from each other.
R^{b} is independently selected from the group consisting of a hydrogen atom, a C₁-C₆ alkyl group, a C₁-C₆ acyl group, and a C₆-C₁₅ aryl group. The plural R^{b}s can be identical with or different from each other.
z represents an integer from 1 to 3.

In the compound represented by Formula (1), preferably, at least one of R^{a} represents an alkyl group having a succinic acid anhydride substituent. Examples of the alkyl group having a carboxylic acid anhydride substituent are a methyl, ethyl, n-propyl, isopropyl, n-butyl, tert-butyl, n-hexyl, and n-decyl. In another aspect, the alkyl group, alkenyl group and aryl group of the other R^{a} without a succinic acid anhydride substituent may be with or without a substituent depending on the feature needed. In one embodiment of the invention, in the other R^{a} without a succinic acid anhydride substituent, the C₁-C₁₀ alkyl group is methyl, ethyl, n-propyl, isopropyl, n-butyl, tert-butyl, n-hexyl, n-decyl, trifluoromethyl, 2,2,2-trifluoroethyl, 3,3,3-trifluoropropyl, 3-aminopropyl, 3-mercaptopropyl, or 3-isocyanatopropyl; the C₂-C₁₀ alkenyl group is vinyl, 3-acryloxypropyl or 3-methacryloxypropyl; and the C₆-C₁₅ aryl group is phenyl, tolyl, p-hydroxyphenyl, 1-(p-hydroxyphenyl)ethyl, 2-(p-hydroxyphenyl)ethyl, 4-hydroxy-5-(p-hydroxyphenylcarbonyloxy)pentyl, or naphthyl.

In the compound represented by Formula (1), R^{b} is independently selected from the group consisting of a hydrogen atom, a C₁-C₆ alkyl group, a C₁-C₆ acyl group, and a C₆-C₁₅ aryl group. The plural R^{b}s can be identical with or different from each other. The alkyl group, acyl group and aryl group may be with or without a substituent depending on the feature needed. In one embodiment of the invention, in R^{b}, the C₁-C₆ alkyl group is methyl, ethyl, n-propyl, isopropyl, or n-butyl; the C₁-C₆ acyl group is acetyl; and the C₆-C₁₅ aryl group is phenyl.

In the compound represented by Formula (1), when z denotes 1, the silane compound represents a trifunctional silane; when z denotes 2, the silane compound represents a difunctional silane; when z denotes 3, the silane compound represents a monofunctional silane.

In one preferred embodiment of the invention, the silane compound having a carboxylic acid anhydride substituent represented by Formula (1) includes but is not limited to (i) trifunctional silane; 2-trimethoxysilylethyl succinic anhydride, 3-triphenoxysilylpropyl succinic anhydride, commercially available 3-(trimethoxysilyl)propyl succinic anhydride manufactured by Shin-Etsu (trade name: X-12-967), commercially available 3-(triethoxysilyl)propyl succinic anhydride manufactured by WACKER (trade name: GF-20), 3-trimethoxysilylpropyl glutaric anhydride (TMSG), 3-triethoxysilylpropyl glutaric anhydride, and 3-triphenoxysilylpropyl glutaric anhydride; (ii) difunctional silane: di-n-butoxysilyl dipropylsuccinic anhydride and dimethoxysilyl diethylsuccinic anhydride; (iii) monofunctional silane: phenoxysilyl tripropylsuccinic anhydride, methylmethoxysilyl diethylsuccinic anhydride. The aforesaid examples of the silane compound can be used alone or as a mixture of two or more.

In one another preferred embodiment of the invention, the silane compound includes but is not limited to a structure represented by Formula (2);

Si(R¹)_{y}(OR^{j})_{4-y} Formula (2)
wherein:
R′ is independently selected from the group consisting of a hydrogen atom, a C₁-C₁₀ alkyl group, a C₂-C₁₀ alkenyl group, and a C₆-C₁₅ aryl group. The C₁-C₁₀ alkyl group is without a carboxylic acid anhydride. The plural Rⁱs can be identical with or different from each other.
R^{j} is independently selected from the group consisting of a hydrogen atom, a C₁-C₆ alkyl group, a C₁-C₆ acyl group, and a C₆-C₁₅ aryl group. The plural R^{j}s can be identical with or different from each other.
y represents an integer from 1 to 3.

The silane compound without a carboxylic acid anhydride substituent represented by Formula (2) includes but is not limited to (i) tetrafunctional silane: tetramethoxysilane, tetraethoxysilane, tetraacetoxysilane, and tetraphenoxy silane; (ii) trifunctional silane: methyltrimethoxysilane (MTMS), methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, vinyltrimethoxysilane, vinyltriethoxysilane, 3-acryloyloxypropyltrimethoxysilane, 3-acryloyloxypropyltriethoxysilane, 3-methylacryloyloxypropyltrimethoxysilane, 3-methylacryloyloxypropyltriethoxysilane, phenyltrimethoxysilane (PTMS), phenyltriethoxysilane (PTES), p-hydroxyphenyltrimethoxysilane, 1-(p-hydroxyphenyl)ethyltrimethoxysilane, 2-(p-hydroxyphenyl)ethyltrimethoxysilane, 4- hydroxy-5-(p-hydroxyphenylcarbonyloxy)pentyltrimethoxysilane, trifluoromethyltrimethoxysilane, trifluoromethyltriethoxysilane, 3,3,3-trifluoropropyltrimethoxysilane, 3-aminopropyltrimethoxysilane, 3-aminopropyltriethoxysilane, 3-glycidoxypropyltrimethoxysilane, 3-glycidoxypropyltriethoxysilane, 2-(3,4-epoxycyclohexyl)ethyltrimethoxysilane, 3-mercaptopropyltrimethoxysilane, 2-oxetanylbutoxypropyltriphenoxysilane, commercially available 2-oxetanylbutoxypropyltrimethoxysilane manufactured by Toagosei (trade name: TMSOX), and commercially available 2-oxetanylbutoxypropyltriethoxysilane manufactured by Toagosei (trade name: TESOX); (iii) difunctional silane: dimethyldimethoxysilane (DMDMS), dimethyldiethoxysilane, dimethyldiacetyloxysilane, di-n-butyldimethoxysilane, diphenyldimethoxysilane, diisopropoxy-di(2-oxetanylbutoxypropyl)silane (DIDOS), and di(3-oxetanylpentyl)dimethoxysilane; and (iv) monofunctional silane: trimethylmethoxysilane, tri-n-butylethoxysilane, 3-glycidoxydimethylmethoxysilane, 3-glycidoxydimethylethoxysilane, di(2-oxetanylbutoxypentyl)2-oxetanylpentylethoxysilane, and tri(2-oxetanylpentyl)methoxysilane. The aforesaid examples of the silane compound can be used alone or as a mixture of two or more.

In one embodiment of the invention, when copolymerizing the compound represented by Formula (1), the ring of carboxylic acid anhydride breaks automatically and the compound contains a hydrophilic carboxylic acid group. The polysiloxane (A-1) obtained thereby has a better sensitivity to a basic development solution. The temperature of the copolymerization is what the ring of carboxylic acid anhydride breaks completely; preferably, the copolymerization is carried out at a temperature higher than 100° C. for 30 minutes.

According to the invention, when the carboxylic acid anhydride carried out a ring breakage reaction, the molar ratio of the broken ring to the polysiloxane (A-1) in Si atom is not limited; and preference is more than 10 mol %. When the content of the carboxylic acid group is less than 10 mol %, the hydrophilicity of the polysiloxane (A-1) is not sufficient. Therefore, when the pattern coated thereby is subjected to the basic development solution, the sensitivity and development is not satisfactory. The method for assaying the content of the carboxylic acid group includes but is not limited to the process described below.

First, the polysiloxane (A-1) is mixed with 1% by weight of benzene as a standard, and subjected to an elementary analysis and ¹H-NMR assay. The molar ratio of the benzene to the Si atom is calculated in the elementary analysis. The peak area of the carboxylic acid (the solvent used: CDCl₃ in ¹H-NMR) and that of the benzene is calculated in the ¹H-NMR assay. The molar ratio of the broken ring of the carboxylic acid anhydride to the polysiloxane (A-1) in Si atom is calculated based on the molar number of the benzene.

In one another preferred embodiment of the invention, the siloxane prepolymer includes but is not limited to a structure represented by Formula (3);

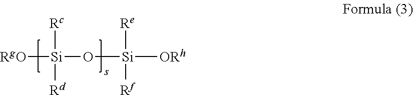

wherein:
R^{c}, R^{d}, R^{e}, and R^{f} represent, respectively and independently, a hydrogen atom, a C₁-C₁₀ alkyl group, a C₂-C₆ alkenyl group, or a C₆-C₁₅ aryl group; wherein the alkyl group, alkenyl group or aryl group preferably contains a sub stituent;
s represents an integer ranging from 1 to 1,000; preferably from 3 to 300; and more preferably from 5 to 200.

When s represents an integer from 2 to 1,000, the plural R^{c}s and R^{d}s can be respectively identical with or different from each other. Examples of the alkyl group include, but are not limited to, methyl, ethyl, n-propyl, or the like. Examples of the alkenyl group include, but are not limited to, vinyl, acryloxypropyl, methacryloxypropyl, or the like. Examples of the aryl group include, but are not limited to, phenyl, tolyl, naphthyl, or the like.

R^{g} and R^{h} represent, respectively and independently, a hydrogen atom, a C₁-C₆ alkyl group, a C₁-C₆ acyl group, or a C₆-C₁₅ aryl group; wherein the alkyl group, acyl group or aryl group preferably contains a substituent. Examples of the alkyl group include, but are not limited to, methyl, ethyl, n-propyl, isopropyl, n-butyl, or the like. Examples of the acyl group include, but are not limited to, acetyl, or the like. Examples of the aryl group include, but are not limited to, phenyl, or the like.

Examples of the siloxane prepolymer include, but are not limited to, 1,1,3,3-tetramethyl-1,3-dimethoxydisiloxane, 1,1,3,3-tetramethyl-1,3-diethoxydisiloxane, 1,1,3,3-tetraethyl-1,3-diethoxydisiloxane, commercially available silanol terminal siloxane prepolymers manufactured by Gelest Inc. for example, DM-S12 (molecular weight: 400-700), DMS-S15 (molecular weight: 1,500-2,000), DMS-S21 (molecular weight: 4,200), DMS-S27 (molecular weight: 18,000), DMS-S31 (molecular weight:26,000), DMS-S32 (molecular weight: 36,000), DMS-S33 (molecular weight: 43,500), DMS-S35 (molecular weight: 49,000), DMS-S38 (molecular weight: 58,000), DMS-S42 (molecular weight: 77,000), PDS-9931 (molecular weight: 1,000-1,400), or the like. The aforesaid examples of the siloxane prepolymer can be used alone or as a mixture of two or more.

When the silane compound and the siloxane prepolymer are used in combination, there is no specific limitation to the mixing ratio thereof. Preferably, the molar ratio of the silane compound and the siloxane prepolymer in Si atom ranges from 100:0.01 to 50:50.

In one another preferred embodiment of the invention, besides of obtained by hydrolyzing and condensing a silane compound and/or a siloxane prepolymer, the polysiloxane can also be prepared via a copolymerization by mixing the silane compound and/or siloxane prepolymer with silicon dioxide particles. There is no specific limitation to the mean particle size of the silicon dioxide particles. The mean particle size of the silicon dioxide particles ranges generally from 2 nm to 250 nm, preferably from 5 nm to 200 nm, and more preferably from 10 nm to 100 nm.

Examples of the silicon dioxide particles include commercially available products manufactured by Catalysts and Chemicals Ltd., for example, OSCAR 1132 (particle size: 12 nm, dispersant: methanol), OSCAR 1332 (particle size: 12 nm, dispersant: n-propanol), OSCAR 105 (particle size: 60 nm, dispersant: γ-butyrolactone), OSCAR 106 (particle size: 120 nm, dispersant: diacetone alcohol), or the like; commercially available products manufactured by Fuso Chemical Co., Ltd., for example, Quartron PL-1-IPA (particle size: 13 nm, dispersant: isopropanone), Quartron PL-1-TOL (particle size: 13 nm, dispersant: toluene), Quartron PL-2L-PGME (particle size: 18 nm, dispersant: propylene glycol monomethyl ether), Quartron PL-2L-MEK (particle size: 18 nm, dispersant: methyl ethyl ketone), or the like; commercially available products manufactured Nissan Chemical, for example, IPA-ST (particle size: 12 nm, dispersant: isopropanol), EG-ST (particle size: 12 nm, dispersant: ethylene glycol), IPA-ST-L (particle size: 45 nm, dispersant: isopropanol), IPA-ST-ZL (particle size: 100 nm, dispersant: isopropanol), or the like. The aforesaid silicon dioxide particles can be used alone or as a mixture of two or more.

There is no specific limitation to the amounts when mixing the silicon dioxide particles with the silane compound and/or the siloxane prepolymer. Preferably, the molar ratio of the silicon dioxide particles to the polysiloxane (A-1) in Si atom ranges from 1% to 50%.

The synthesis of the polysiloxane (A-1) according to the invention includes but is not limited to hydrolyzing and condensing a silane compound and/or a siloxane prepolymer, and silicon dioxide particles; preferably hydrolyzing and condensing the silane compound represented by Formula (1) or (2). Preferably, a solvent, such as water, and optionally a catalyst are added to the reaction mixture, followed by stirring at a high temperature. During stirring, the by-products of hydrolysis such as alcohols (e.g. methanol) and the by-products of condensation such as water, can be removed by distillation if necessary.

There is no specific limitation to the solvent of synthesizing the polysiloxane (A-1), which can be identical with the organic solvent (D) as mentioned below. The solvent is used in an amount ranging generally from 10 wt % to 1000 wt %, preferably 100 wt %, based on 100 wt % of the total organic silane. When water is applied as the solvent, the amount of water for the hydrolysis ranges from 0.5 to 2 moles based on 1 mole of the hydrolyzable groups contained in the mixture.

There is no specific limitation to the catalyst optionally added in the synthesis of the polysiloxane (A-1), and an acid catalyst or a base catalyst can be preferably used. Examples of the acid catalyst include hydrochloric acid, nitric acid, sulfuric acid, hydrofluoric acid, oxalic acid, phosphoric acid, acetic acid, trifluoroacetic acid, formic acid, polycarboxylic acids and anhydrides thereof. Examples of the base catalyst include diethylamine, triethylamine, tripropylamine, tributylamine, tripentylamine, trihexylamine, triheptylamine, trioctylamine, diethanolamine, triethanolamine, sodium hydroxide, potassium hydroxide hydrate, and compounds containing an amino group. Preferably, the catalyst is used in an amount ranging generally from 0.01 wt % to 1 wt %, based on 100 wt % of the total organic silane.

In view of the coatability and storage stability, it is preferable that the by-products (for example, alcohols or water) and the catalyst are not contained in polysiloxane (A-1) produced after hydrolysis and condensation. Therefore, purification is carried out if necessary. There is no specific limitation to the purification method. Preferably, the polysiloxane (A-1) is diluted with a hydrophobic solvent, and the organic layer washed with water several times is then concentrated with an evaporator to remove alcohols and water. Additionally, the catalyst can be removed using ion exchange resin or using the wash with water as mentioned above.

One of the technical features of the invention is using a polyxiloxane (A-1) containing a carboxylic acid anhydride sub stituent, and the contrast and adhesion of the filter produced thereby is enhanced dramatically. To the contrary, the contrast and adhesion of the filter produced thereby is not satisfactory if the polysiloxane (A-1) containing a carboxylic acid anhydride sub stituent is absent.

According to the invention, the amount of the polysiloxane (A-1) used is preferably from 5 to 70 parts by weight based on 100 parts by weight of the alkali-soluble resin (A) used; more preferably from 8 to 65 parts by weight; still more preferably from 10 to 60 parts by weight. The contrast and adhesion of the filter produced thereby is enhanced dramatically when applying the photosensitive resin composition.

In one preferred embodiment of the invention, the alkali-soluble resin (A) further comprises an acrylic resin (A-2). In one preferred embodiment of the invention, the acrylic resin (A-2) is obtained by copolymerizing an ethylenically unsaturated monomer having one or more carboxyl groups and another copolymerizable ethylenically unsaturated monomer. Preferably, 50 to 95 parts by weight of the ethylenically unsaturated monomer having one or more carboxyl groups and 5 to 50 parts by weight of the another copolymerizable ethylenically unsaturated monomer used in the copolymerization reaction based on 100 parts by weight of the sum of the ethylenically unsaturated monomer having one or more carboxyl groups and the another copolymerizable ethylenically unsaturated monomer.

Examples of the aforementioned ethylenically unsaturated monomer having one or more carboxyl groups include, but are not limited to, unsaturated monocarboxylic acids, such as acrylic acid, methacrylic acid, butenoic acid, α-chloroacrylic acid, ethacrylic acid, cinnamic acid, 2-acryloylethoxy succinate, 2-methacryloylethoxy succinate, 2-isobutyrylethoxy succinate, or the like; unsaturated dicarboxylic acids and/or anhydrides thereof, such as maleic acid, maleic anhydride, fumaric acid, itaconic acid, itaconic anhydride, citraconic acid, citraconic anhydride, or the like; and unsaturated polycarboxylic acids having at least three carboxyl groups in the molecules and/or anhydrides thereof; or the like. Preferably, the ethylenically unsaturated monomer having one or more carboxyl groups is selected from acrylic acid, methacrylic acid, 2-acryloylethoxy succinate, 2-methacryloylethoxy succinate and 2-isobutyrylethoxy succinate. More preferably, the ethylenically unsaturated monomer having one or more carboxyl groups is selected from 2-acryloylethoxy succinate and 2-methacryloylethoxy succinate. The ethylenically unsaturated monomer having one or more carboxyl groups is used for increasing the pigment dispersion, enhancing the development speed, and reducing the residue.

Examples of the another copolymerizable ethylenically unsaturated monomer include, but are not limited to, vinyl aromatic compounds, such as styrene, a-methyl styrene, o-vinyl toluene, p-chlorostyrene, methoxystyrene, or the like; maleimides, such as N-phenylmaleimide, N-o-hydroxyphenylmaleimide, N-m-hydroxyphenylmaleimide, N-p-hydroxyphenylmaleimide, N-o-methylphenylmaleimide, N-m-methylphenylmaleimide, N-p-methylphenylmaleimide, N-o-methoxyphenylmaleimide, N-m-methoxyphenylmaleimide, N-p-methoxyphenylmaleimide, N-cyclohexylmaleimide, or the like; unsaturated carboxylates, such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, docosyl methacrylate, dicyclopentenyloxyethyl acrylate, or the like; unsaturated amino alkyl carboxylates, such as N,N-dimethyl aminoethyl acrylate, N,N-dimethyl aminoethyl methacrylate, N,N-diethyl aminopropyl acrylate, N,N-dimethyl aminopropyl methacrylate, N,N-dibutyl aminopropyl acrylate, N-isobutyl aminopropyl acrylate, or the like; unsaturated glycidyl carboxylates, such as glycidyl acrylate, glycidyl methacrylate, or the like; vinyl carboxylates, such as vinyl acetate, vinyl propionate, vinyl butyrate, or the like; unsaturated ethers, such as vinyl methyl ether, vinyl ethyl ether, allyl glycidyl ether, methallyl glycidyl ether, or the like; vinyl cyanides, such as acrylonitrile, methyl acrylonitrile, a-chloroacrylonitrile, vinylidene cyanide, or the like; unsaturated amides, such as acrylamide, methacrylamide, a-chloroacrylamide, N-hydroxyethyl acrylamide, N-hydroxyethyl methacrylamide, or the like; and aliphatic conjugate dienes, such as 1,3-butadiene, iso-propylene, chloroprene, or the like.

Preferably, the another copolymerizable ethylenically unsaturated monomer is selected from styrene, N-phenylmaleimide, methyl acrylate, methyl methacrylate, 2-hydroxyethyl acrylate, 2-hydroxyethyl methacrylate, benzyl acrylate, benzyl methacrylate, acrylic acid, acrylic acid, methacrylic acid, 2-acryloylethoxy succinate, dicyclopentenyloxyethyl acrylate, 2-methacryloylethoxy succinate and 2-isobutyrylethoxy succinate. More preferably, the another copolymerizable ethylenically unsaturated monomer is selected from the ethylenically unsaturated monomers containing a carboxylic acid group, such as 2-acryloylethoxy succinate, 2-methacryloylethoxy succinate and 2-isobutyrylethoxy succinate. The dispersion of the pigment and the rate of the development are enhanced thereby and the residues are eliminated. The aforesaid examples of the ethylenically unsaturated monomer can be used alone or in admixture of two or more thereof.

In another aspect, examples of the solvent suitable for preparing the acrylic resin (A-2) include, but are not limited to, (poly)alkylene glycol monoalkyl ethers, such as ethylene glycol methyl ether, ethylene glycol ethyl ether, diethylene glycol methyl ether, diethylene glycol ethyl ether, diethylene glycol n-propyl ether, diethylene glycol n-butyl ether, triethylene glycol methyl ether, triethylene glycol ethyl ether, propylene glycol methyl ether, propylene glycol ethyl ether, dipropylene glycol methyl ether, dipropylene glycol ethyl ether, dipropylene glycol n-propyl ether, dipropylene glycol n-butyl ether, tripropylene glycol methyl ether, tripropylene glycol ethyl ether, or the like; (poly)alkylene glycol monoalkyl ether acetates, such as ethylene glycol methyl ether acetate, ethylene glycol ethyl ether acetate, propylene glycol methyl ether acetate, propylene glycol ethyl ether acetate, or the like; other ethers, such as diethylene glycol dimethyl ether, diethylene glycol methyl ethyl ether, diethylene glycol diethyl ether, tetrahydrofuran, or the like; ketones, such as methyl ethyl ketone, cyclohexanone, 2-heptanone, 3-heptanone, or the like; alkyl lactate, such as methyl 2-hydroxypropionate, ethyl 2-hydroxypropionate, or the like; other esters, such as methyl 2-hydroxy-2-methylpropionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxy acetate, ethyl hydroxy acetate, methyl 2-hydroxy-3-methylbutyrate, 3-methyl-3-methoxybutyl acetate, 3-methyl-3-methoxybutyl propionate, ethyl acetate, n-propyl acetate, iso-propyl acetate, n-butyl acetate, iso-butyl acetate, n-amyl acetate, iso-amyl acetate, n-butyl propionate, ethyl butyrate, n-propyl butyrate, iso-propyl butyrate, n-butyl butyrate, methyl pyruvate, ethyl pyruvate, n-propyl pyruvate, methyl acetoacetate, ethyl acetoacetate, ethyl 2-oxobutyrate, or the like; aromatic hydrocarbons, such as toluene, xylene, or the like; and carboxylic acid amide, such as N-methyl-2-pyrrolidone, N,N-dimethylformamide, N,N-dimethylacetamide, or the like. Preferably, the solvent is selected from propylene glycol methyl ether acetate and ethyl 3-ethoxypropionate. The aforesaid examples of the solvent can be used alone or in admixture of two or more thereof.

Furthermore, the initiator used for preparing the acrylic resin (A-2) is a free radical polymerization initiator, examples of which include, but are not limited to, azo compounds, such as 2,2′-azobisisobutyronitrile, 2,2′-azobis-(2,4-dimethylvaleronitrile), 2,2′-azobis-(4-methoxy-2,4-dimethylvaleronitrile), 2,2′-azobis-2-methyl butyronitrile, or the like; and peroxides, such as benzoyl peroxide, or the like.

Preferably, the amount of the acrylic resin (A-2) used is from 30 to 95 parts by weight based on 100 parts by weight of the alkali-soluble resin (A) used; more preferably from 35 to 92 parts; still more preferably from 40 to 90 parts. The development of the filter produced thereby is enhanced dramatically when applying the photosensitive resin composition.

The compound having an ethylenically unsaturated group (B) according to the present invention is a compound having at least one ethylenically unsaturated group. Examples of the compound having an ethylenically unsaturated group include, but are not limited to, acrylamide, (meth) acryloylmorpholine, 7-amino-3,7-dimethyloctyl (meth)acrylate, iso-butoxymethyl (meth)acrylamide, iso-bornyloxyethyl (meth)acrylate, iso-bornyl (meth)acrylate, 2-ethylhexyl (meth)acrylate, ethyl diethylene glycol(meth)acrylate, t-octyl(meth)acrylamide, diacetone(meth)acrylamide, dimethylaminoethyl(meth)acrylate, dodecyl(meth)acrylate, dicyclopentenyloxyethyl(meth)acrylate, dicyclopentenyl(meth)acrylate, N,N-dimethyl(meth)acrylamide, tetrachlorophenyl (meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate, bornyl(meth)acrylate, or like.

Examples of the compound having two or more ethylenically unsaturated groups include, but are not limited to, ethylene glycol di(meth)acrylate, dicyclopentenyl di(meth)acrylate, triethylene glycol diacrylate, tetraethylene glycol di(meth)acrylate, tri(2-hydroxyethyl) isocyanate di(meth)acrylate, tri(2-hydroxyethyl) isocyanate tri(meth)acrylate, caprolactone-modified tri(2-hydroxyethyl) isocyanate tri(meth)acrylate, trimethylolpropyl tri(meth)acrylate, ethylene oxide (hereinafter abbreviated as EO) modified trimethylolpropyl tri(meth)acrylate, propylene oxide (hereinafter abbreviated as PO) modified trimethylolpropyl tri(meth)acrylate, tripropylene glycol di(meth)acrylate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, ditrimethylolpropyl tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol triacrylate, EO-modified bisphenol F di(meth)acrylate, phenol novolac polyglycidyl ether(meth)acrylate, or the like.

Preferably, the compound having an ethylenic group is selected from trimethylolpropyl triacrylate, EO-modified trimethylolpropyl triacrylate, PO-modified trimethylolpropyl triacrylate, pentaerythritol triacrylate, pentaerythritol tetracrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, and PO-modified glycerol triacrylate. The aforesaid examples of the compound having an ethylenic group can be used alone or in admixture of two or more thereof.

Preferably, the amount of the compound having an ethylenically unsaturated group (B) used is from 10 to 500 parts by weight (0.1 to 5 times) based on 100 parts by weight of the alkali-soluble resin (A) used; more preferably, the amount of the compound having an ethylenically unsaturated group (B) used is from 30 to 400 parts by weight (0.3 to 4 times) based on 100 parts by weight of the alkali-soluble resin (A) used; still more preferably, the amount of the compound having an ethylenically unsaturated group (B) used is from 50 to 300 parts by weight (0.5 to 3 times) based on 100 parts by weight of the alkali-soluble resin (A) used.

The photoinitiator (C) suitable for the present invention can be chosen by skilled artisans in this field, such as 0-acyloxime compounds, triazine compounds, acetophenone compounds, biimidazole compounds, or benzophenone compounds.

Preferably, the amount of the photoinitiator (C) used is from 2 to 200 parts by weight based on 100 parts by weight of the alkali-soluble resin (A) used; more preferably the amount of the photoinitiator (C) used is from 5 to 180 parts by weight; still more preferably, the photoinitiator (C) used is from 10 to 150 parts by weight.

Examples of the O-acyloxime compounds include, but are not limited to, 1-[4-(phenylthio)phenyl]-heptane-1,2-dione 2-(O-benzoyloxime), 1-[4-(phenylthio)phenyl]-octane -1,2-dione 2-(O-benzoyloxime), 1-[4-(benzoyl)phenyl]-heptane-1,2-dione 2-(O-benzoyloxime), 1-[9-ethyl-6-(2-methylbenzoyl)-9H-carbazol-3-yl]-ethylketo 1-(O-acetyloxime), 1-[9-ethyl-6-(3-methylbenzoyl)-9H-carbazol-3-yl]-ethylketo 1-(O-acetyloxime), 1-[9-ethyl-6-benzoyl-9H-carbazol-3-yl]-ethylketo 1-(O-acetyloxime), ethylketo-1-[9-ethyl-6-(2-methyl-4-tetrahydrofurylbenzoyl)-9H-carbazol-3-yl]-1-(O-acetyloxime), ethylketo-1-[9-ethyl-6-(2-methyl-4-tetrapyranylbenzoyl)-9H-carbazol-3-yl]-1-(O-acetyloxime), ethylketo-1-[9-ethyl-6-(2-methyl-5-tetrafurylbenzoyl)-9H-carbazol-3-yl]-1-(O-acetyloxime), ethylketo-1-[9-ethyl-6-(2-methyl-5-tetrapyranylbenzoyl)-9H-carbazol-3-yl]-1-(O-acetyloxime), ethylketo-1-[9-ethyl-6-(2-methyl-4-tetrafurylmethoxybenzoyl)-9H-carbazol-3-yl]-1-(O-acetyloxime), ethylketo-1-[9-ethyl-6-(2-methyl-4-tetrapyranylmethoxybenzoyl)-9H-carbazol-3-yl]-1-(O-acetyloxime), ethylketo-1-[9-ethyl-6-(2-methyl-5-tetrafurylmethoxybenzoyl)-9H-carbazol-3-yl]-1-(O-acetyloxime), ethylketo-1-[9-ethyl-6-(2-methyl-5-tetrapyranylmethoxybenzoyl)-9H-carbazol-3-yl]-1-(O-acetyloxime), ethylketo-1-[9-ethyl-6-{2-methyl-4-(2,2-dimethyl-1,3-dioxolyl)benzoyl}-9H-carbazol-3-yl]-1-(O-acetyloxime), ethylketo-1-[9-ethyl-6-{2-methyl-4-(2,2-dimethyl-1,3-dioxolyl)methoxybenzoyl}-9H-carbazol-3-yl]-1-(O-acetyloxime), or the like.

Examples of the triazine compounds include, but are not limited to, 2,4-bis(trichloromethyl)-6-(p-methoxy)styryl- s-triazine, 2,4-bis(trichloromethyl)-6-(1-p-dimethylaminophenyl-1,3-butadienyl)-s-triazine, 2-trichloromethyl-4-amino-6-(p-methoxy)styryl-s-triazine, or the like.

Examples of the acetophenone compounds include, but are not limited to, p-dimethylaminoacetophenone, a,a′-dimethoxyazoxyacetophenone, 2,2′-dimethyl-2-phenylacetophenone, p-methoxyacetophenone, 2-methyl-1-(4-methylthiophenyl)-2-morpholino-1-propanone, 2-benzyl-2-N,N-dimethylamino-1-(4-morpholinophenyl)-1-butanone, or the like.

Examples of the biimidazole compounds include, but are not limited to, 2,2′-bis(o-chlorophenyl)-4,4′,5,5′-tetraphenylbiimidazole, 2,2′-bis(o-fluorophenyl)-4,4′,5,5′-tetraphenylbiimidazole, 2,2′-bis(o-methylphenyl)-4,4′,5,5′-tetraphenylbiimidazole, 2,2′-bis(o-methoxyphenyl)-4,4′,5,5′-tetraphenylbiimidazole, 2,2′-bis(o-ethylphenyl)-4,4′,5,5′-tetraphenylbiimidazole, 2,2′-bis(p-methoxyphenyl)-4,4′,5,5′-tetraphenylbiimidazole, 2,2′-bis(2,2′,4,4′-tetramethoxyphenyl)-4,4′,5,5′-tetraphenylbiimidazole, 2,2′-bis(2-chlorophenyl)-4,4′,5,5′-tetraphenylbiimidazole, 2,2′-bis(2,4- dichlorophenyl)-4,4′,5,5′-tetraphenylbiimidazole, or the like.

Examples of the benzophenone compounds include, but are not limited to, thioxanthone, 2,4-diethylthioxanthone, thioxanthone-4-sulfone, benzophenone, 4,4′-bis(dimethylamino)benzophenone, 4,4′-bis(diethylamino)benzophenone, or the like.

Preferably, the photoinitiator (C) is selected from 1-[4-(phenylthio)phenyl]-octane-1,2-dione 2-(O-benzoyloxime), 1-[9-ethyl-6-(2-methylbenzoyl)-9H-carbazol-3-yl]-ethylketo 1-(O-acetyloxime), ethylketo-1-[9-ethyl-6-(2-methyl-4-tetrahydrofurylmethoxybenzoyl)-9H-carbazol-3-yl]-1-(O-acetyloxime), ethylketo-1-[9-ethyl-6-{2-methyl-4-(2,2-dimethyl-1,3-dioxolyl)methoxybenzoyl}-9H-carbazol-3-yl]-1-(O-acetyloxime), 2,4-bis(trichloromethyl)-6-(p-methoxy) styryl-s-triazine, 2-benzyl-2-N,N-dimethylamino-1-(4-morpholinophenyl)-1-butanone, 2,2′-bis(2,4- dichlorophenyl)-4,4′,5,5′-tetraphenylbiimidazole, and 4,4′-bis(diethylamino)benzophenone.

In addition to the aforesaid photoinitiators, other initiators can be further added into the photosensitive resin composition of the present invention. Examples of the other initiators include, but are not limited to, α-diketone compounds, acyloin compounds, acyloin ether compounds, acylphosphine oxide compounds, quinone compounds, halide compounds, and peroxide compounds.

Examples of α-diketone compounds are benzil, acetyl, or the like; examples of acyloin compounds are benzoin, or the like; examples of acyloin ether compounds are benzoin methyl ether, benzoin ethyl ether, benzoin isopropyl ether, or the like; examples of acylphosphine oxide compounds are 2,4,6-trimethylbenzoyl diphenylphosphine oxide, bis-(2,6-dimethoxybenzoyl)-2,4,4-trimethyl benzyl phosphine oxide, or the like; examples of quinone compounds are anthraquinone, 1,4-naphthoquinone, or the like; examples of halide compounds are phenacyl chloride, tribromomethyl phenylsulfone, tris(trichloromethyl)-s-triazine, or the like; and examples of peroxide compounds are di-tert-butyl peroxide; or the like. The aforesaid examples of the photoinitiator (C) can be used alone or as a mixture of two or more.

The organic solvent (D) according to the invention can be chosen by skilled artisans in this field. Any solvents, which are inert to and can disperse or dissolve the alkali-soluble resin (A), the compound having an ethylenically unsaturated group (B) and the photoinitiator (C) and which have appropriate volatility, can be used.

Preferably, the amount of the organic solvent (D) used is from 500 to 5,000 parts by weight based on 100 parts by weight of the alkali-soluble resin (A) used; more prefrerably, the amount of the organic solvent (D) used is from 800 to 4,500 parts; still more preferably, the amount of the organic solvent (D) used is from 1,000 to 4,000 parts.

In one embodiment of the invention, the organic solvent (D) can be selected from the examples of the solvent for preparing acrylic resin (A-2) and not described herein again. Preferably, the organic solvent (D) is propylene glycol methyl ether acetate or ethyl 3-ethoxypropionate. The examples of the organic solvent (D) can be used alone or in combinations thereof.

The pigment (E) according to the invention comprises a blue pigment (E-1) as a main pigment. The blue pigment (E-1) can be chosen by skilled artisans in this field. Examples of the blue pigment (E-1) are C.I. Pigment Blue 15:1, 15:2, 15:3, 15:4, 15:6, 21, 22, 60, and 64.

Preferably, the pigment (E) according to the invention further comprises a violet pigment (E-2). The violet pigment (E-2) can be chosen by skilled artisans in this field. Examples of the violet pigment (E-2) are C.I. Pigment Violet 19, 23, 29, 32, 33, 36, 37, 38, 40, and 50.

According to the invention, the amount of the pigment (E) used is preferably from 50 to 99.5 wt % based on 100 wt % of the total amount of the pigment (E) and the dye (F) used; more preferably, 55 to 99.0 wt %; still more preferably, 60 to 98.0 wt %.

According to the invention, the color difference of the color filter produced thereby after the post-bake is not satisfactory without the pigment (E).

The dye (F) according to the present invention can be used with the use of the pigment (E). The dye (F) with a specific spectrum can be chosen by skilled artisans in this field. In the embodiment of the invention, the dye (F) is azo dyes, azo-metal complex dyes, anthraquinone dyes, indigo dyes, thioindigo dyes, phthalocyanine dyes, diphenylmethane dyes, triphenylmethane dyes, xanthene dyes, thiazine dyes, cationic dyes, cyanine dyes, nitro dyes, quinoline dyes, naphthoquinone dyes, oxazine dyes, or the like.

In one preferred embodiment of the invention, the dye (F) is C.I. Solvent Red 2, C.I. Solvent Red 24, C.I. Solvent Red 27, C.I. Solvent Red 49, C.I. Solvent Red 52, C.I. Solvent Red 57, C.I. Solvent Red 89, C.I. Solvent Red 111, C.I. Solvent Red 114, C.I. Solvent Red 119, C.I. Solvent Red 124, C.I. Solvent Red 135, C.I. Solvent Red 136, C.I. Solvent Red 137, C.I. Solvent Red 138, C.I. Solvent Red 139, C.I. Solvent Red 143, C.I. Solvent Red 144, C.I. Solvent Red 145, C.I. Solvent Red 146, C.I. Solvent Red 147, C.I. Solvent Red 148, C.I. Solvent Red 149, C.I. Solvent Red 150, C.I. Solvent Red 151, C.I. Solvent Red 152, C.I. Solvent Red 155, C.I. Solvent Red 156, C.I. Solvent Red 162, C.I. Solvent Red 168, C.I. Solvent Red 169, C.I. Solvent Red 170, C.I. Solvent Red 171, C.I. Solvent Red 172, C.I. Solvent Red 177, C.I. Solvent Red 178, C.I. Solvent Red 179, C.I. Solvent Red 181, C.I. Solvent Red 190, C.I. Solvent Red 191, C.I. Solvent Red 194, C.I. Solvent Red 199, C.I. Solvent Red 200, C.I. Solvent Red 201, C.I. Solvent Red 299, C.I. Direct Red 2, C.I. Direct Red 81, C.I. Acid Red 1, C.I. Acid Red 14, C.I. Acid Red 27, C.I. Acid Red 52, C.I. Acid Red 87, C.I. Acid Red 88, C.I. Acid Red 289, C.I. Basic Red 1, C.I. Mordant Red 3, C.I. Azoic Red 21, C.I. Vat Red 1, C.I. Vat Red 2, C.I. Vat Red 15, C.I. Vat Red 23, C.I. Vat Red 41, C.I. Vat Red 47, C.I. Disperse Red 1, C.I. Disperse Red 11, C.I. Disperse Red 15, C.I. Disperse Red 22, C.I. Disperse Red 60, C.I. Disperse Red 92, C.I. Disperse Red 146, C.I. Disperse Red 191, C.I. Disperse Red 283, C.I. Disperse Red 288, C.I. Reactive Red 12. The aforesaid examples of the dye can be used alone or as a mixture of two or more according to the property.

According to the invention, the contrast of the color filter and the smoothness of the pixel pattern edges after development are not satisfactory without the dye (F).

According to the invention, the amount of the dye (F) used is preferably from 0.5 to 50 wt % based on 100 wt % of the total amount of the pigment (E) and the dye (F) used; more preferably, 1.0 to 45 wt %; still more preferably, 2.0 to 40 wt %.

According to the invention, when the amount of the dye (F) used is from 0.5 to 50 wt % based on 100 wt % of the total amount of the pigment (E) and the dye (F) used, the color difference of the color filter is lower, besides, the shortcomings of the poor contrast and the issue of the smoothness of the pixel pattern edges are avoided.

Preferably, the total amount of the pigment (E) and the dye (F) used is from 100 to 800 parts by weight based on 100 parts by weight of the alkali-soluble resin (A) used; more preferably, from 120 to 700 parts; still more preferably, from 150 to 600 parts.

Preferably, the photosensitive resin composition according to the present invention can contain other additives according to the specific requirements for the physical and/or chemical properties. The additives can be chosen by skilled artisans in the field. Examples of the additives are fillers, polymers other than the alkali-soluble resin (A), adhesion agents, antioxidants, UV absorbents, anti-coagulants, or the like.

In the preferred embodiment of the invention, the fillers include glass, alumina, or the like. Examples of the polymers other than the alkali-soluble resin (A) include polyvinyl alcohol, polyethylene glycol monoalkyl ether, polyfluoro alkyl acrylate, or the like. Examples of the adhesion agents include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidyloxypropyltrimethoxysilane, 3-glycidyloxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryl oxypropyltrimethoxysilane, 3-mercaptopropyltrimethoxysilane, or the like. Examples of the antioxidants include 2,2-thiobis(4-methyl-6-t-butylphenol), 2,6-di-t-butylphenol, or the like. Examples of the UV absorbents include 2-(3-t-butyl-5-methyl-2-hydroxyphenyl)-5-chlorobenzotriazole, alkoxybenzophenone, or the like. Examples of the anti-coagulants include sodium polyacrylate, or the like.

The amount of the additives according to the invention can be chosen by skilled artisans in this field. Preferably, The other additives are used in an amount ranging generally from 0 to 10 parts by weight, preferably from 0 to 6 parts by weight, and more preferably from 0 to 3 parts by weight, based on 100 parts by weight of the alkali-soluble resin (A).

The present invention also provides a method for manufacturing a color filter comprising forming a pattern with the photosensitive resin composition as mentioned above.

The present invention also provides a color filter manufactured by the method as mentioned above.

The manner for manufacturing the color filter by applying the photosensitive resin composition according to the invention can be carried out by skilled artisans in the field. In one embodiment of the invention, the photosensitive resin composition in a liquid state for the color filter in the present invention can be formed by blending the alkali-soluble resin (A), the compound having an ethylenically unsaturated group (B), the photoinitiator (C), and the pigment (E) with the dye (F) in the organic solvent (D) using a mixer. The blue photosensitive resin composition is coated on a substrate by a spin coating method, a knife coating method, an ink-jet coating method, a roller coating method, or the like, and is then dried under reduced pressure to remove most of the solvent. After completely evaporating the residual solvent by pre-baking, a coating film is formed. Operation conditions for the drying under reduced pressure and the pre-baking depend on kinds and amounts of the components used in the photosensitive resin composition. In general, the drying under reduced pressure is carried out at a pressure from 0 to 200 mm Hg for a period from 1 to 60 seconds. The pre-baking is carried out at a temperature from 70° C. to 110° C. for a period from 1 to 15 minutes. The coating film is then exposed to UV light through a specific photo mask, and is developed in a developer solution at a temperature of 23±2° C. for a period from 15 seconds to 5 minutes to dissolve and remove the unexposed portions of the coating film so as to obtain a desired pattern. The substrate with the desired pattern of the coating film is washed with water, is dried with compressed air or compressed nitrogen, and is heated at a temperature from 100 to 280° C. for a period of 1 to 15 minutes in a heating device, such as a hot plate or an oven so as to remove evaporative components and to subject the unreacted ethylenic compound contained in the coating film to conduct a heat curing reaction. The blue filter segment can be obtained thereby. The green and red filter segments can be obtained using the green and red photosensitive resin compositions, respectively, following the procedure for making the green filter segment and the red filter segment. A color filter can be obtained thereby.

Preferably, the UV light used for the exposure of the coating film can be g line, h line, i line, or the like. The UV lamp for providing the UV light is a (ultra)high-pressure mercury lamp or a metal halide lamp. The substrate used to form the color filter is made from bare glass, soda glass, Pyrex glass, silica glass, or any one of these glass coated with a transparent conductive film, or a transparent electrode substrate (such as a Si substrate) used in solid state image pick up devices. A black matrix is formed on the substrate to separate each color pixel element.

In one preferred embodiment of the invention, the developer solution is preferably an alkali aqueous solution of sodium hydroxide, potassium hydroxide, sodium carbonate, sodium hydrogencarbonate, potassium carbonate, potassium hydrogencarbonate, sodium silicate, sodium methylsilicate, aqueous ammonia, ethylamine, diethylamine, dimethyl ethanolamine, tetramethylammonium hydroxide, tetraethylammonium hydroxide, choline, pyrrole, piperidine, 1,8-diaza-bicyclo(5,4,0)-7-undecene, or the like. The concentration of the developer in the solution is from 0.001 wt % to 10 wt %, preferably from 0.005 wt % to 5 wt %, and more preferably from 0.01 wt % to 1 wt %.

The present invention further provides a liquid crystal display device comprising the color filter as mentioned above.

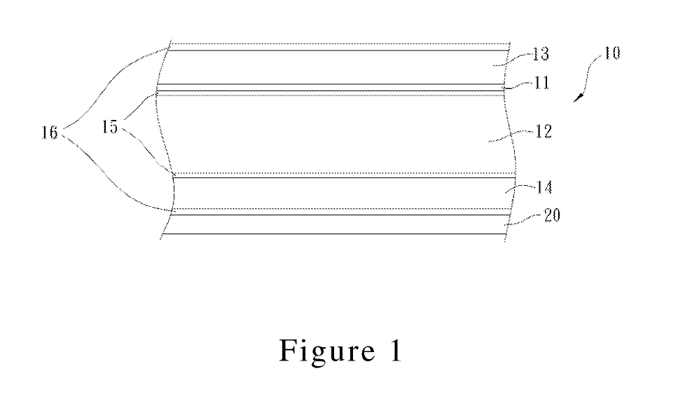

The liquid crystal display device usually contains a color liquid crystal display device. Referring to FIG. 1 showing an embodiment of the invention, the color liquid crystal display device of the present invention includes the liquid crystal display element 10 and the backlight unit 20.

The liquid crystal display element 10 includes the first substrate 13, the second substrate 14 spaced apart from the first substrate 13, the color filter 11 coupled to the first substrate 13, two alignment layers 15 respectively disposed on the color filter 11 and the second substrate 14 and facing toward each other, liquid crystal 12 disposed between the alignment layers 15, and two polarizers 16 respectively coupled to the first and second substrates 13, 14 and distal from the liquid crystal 12. The first substrate 13 is a color filter side substrate, and the second substrate 14 is a thin film transistor side substrate.

The backlight unit 20 is coupled to the polarizers 16 of the second substrate 14 of the liquid crystal display element 10 so as to form the color liquid crystal display device.

The color liquid crystal display device of the present invention can be used with twisted nematic liquid crystal, super twisted nematic liquid crystal, in-plane switching liquid crystal, vertical alignment liquid crystal, optically compensated birefringence liquid crystal, ferroelectric liquid crystal, or the like.

The following examples are given for the purpose of illustration only and are not intended to limit the scope of the present invention.

### EXAMPLE

### Preparation of Polysiloxane (A-1):

A 500 ml three-necked flask was added with the silane compound/siloxane prepolymer, solvent and catalyst as shown in Table 1. Stirring was conducted at room temperature over 30 minutes. The mixture in the flask was then stirred in an oil bath at a temperature of 40° C. for 30 minutes. The temperature of the oil bath was raised to 115° C. within a succeeding 30 minutes. After heating for 1 hour, the temperature of the mixture in the flask reached 100° C. The mixture in the flask was further stirred and heated (the inner temperature is 100 to 110° C.) for 120 minutes. In the reaction, methanol and water were co-volatilized as by-products. Diacetone alcohol was added to the produced solution of the polysiloxane (A-1) and a solution of the 43 wt % polysiloxane (A-1) was obtained. The average molecular weight (Mw) of the polysiloxane (A-1) obtained was shown in Table 1.

TABLE 1
Contents of Preparation of Polysiloxane (A-1)

| | Composition | | | | | | | | | | Reaction | Polycon- | |
|---|---|---|---|---|---|---|---|---|---|---|---|---|---|
| Preparation | Silane Compound/Siloxane prepolymer (mol) | | | | | | Solvent (g) | | Catalyst (g) | | Tempera- | densation | |
| Example | MTMS | DMDMS | PTMS | PTES | GF-20 | X-12-967 | DAA | PGEE | water | Oxalic acid | ture (° C.) | time (hour) | Mw |
| A-1-1 | | 0.23 | 0.70 | | | 0.07 | 200 | | 75 | 0.35 | 105 | 6 | 7200 |
| A-1-2 | | 0.70 | 0.15 | 0.12 | 0.03 | | 100 | 100 | 75 | 0.40 | 110 | 5 | 6100 |
| A-1-3 | 0.50 | | 0.35 | | | 0.15 | 200 | | 75 | 0.40 | 105 | 6 | 8000 |
| A-1-4 | 0.72 | | 0.16 | | 0.09 | 0.03 | 200 | | 75 | 0.35 | 110 | 6 | 10000 |

MTMS: Methyltrimethoxysilane
DMDMS: Dimethyldimethoxysilane
PTMS: Phenyltrimethoxysilane
PTES: Phenyltriethoxysilane
GF-20: 3-(Triethoxysilyl)propyl succinic anhydride
X-12-967: 3-(Trimethoxysilyl)propyl succinic anhydride
DAA: Diacetone alcohol
PGEE: Propylene glycol monoethyl ether

### Preparation of Acrylic Resin (A-2):

A 1000 ml four-necked conical flask equipped with a nitrogen inlet, a stirrer, a heater, a condenser and a thermometer was purged with nitrogen, and the contents and the solvent as shown in Table 2 were added, and the monomer mixture was added continuously.

The contents in the four-necked conical flask were stirred while the temperature of an oil bath was raised to 100° C. As shown in Table 2, 4 parts by weight of 2,2′-azobis-2-methyl butyronitrile (referred to as AMBN hereinafter, as a polymerization initiator) dissolved in EEP was added into the four-necked conical flask in five aliquots within one hour.

Polymerization was conducted at 100° C. for 6 hours. Polymerization product was removed from the four-necked conical flask after the polymerization was complete. The solvent was evaporated so as to obtain the acrylic resin (A-2).

TABLE 2
Contents of Preparation of acrylic resin (A-2)

| | Composition(parts by weight) | | | | | | | | | Reaction | Reaction |
|---|---|---|---|---|---|---|---|---|---|---|---|
| Preparation | Monomer for polymerization | | | | | | | Initiator | Solvent | Temperature | Time |
| Example | MAA | AA | BzMA | FA-512A | MA | MMA | SM | AMBN | EEP | (° C.) | (hour) |
| A-2-1 | 15 | 10 | 45 | 10 | | 20 | | 6 | 200 | 100 | 6 |
| A-2-2 | 15 | | 60 | 10 | | | 15 | 6 | 200 | 100 | 6 |
| A-2-3 | | 20 | | | 30 | | 50 | 6 | 200 | 100 | 6 |
| A-2-4 | 10 | 15 | | 10 | 15 | | 50 | 6 | 200 | 100 | 6 |

MAA: Methacrylic acid
AA: Acrylic acid
BzMA: Benzyl methacrylate
FA-512A: Dicyclopentenyloxyethyl acrylate
MA: Methyl acrylate
MMA: Methyl methacrylate
SM: Styrene
AMBN: 2,2′-Azobis-2-methyl butyronitrile
EEP: Ethyl 3-ethoxypropionate

### Preparation of Photosensitive Resin Composition:

The compositions and amounts shown in Table 3 were mixed and dissolved using a shaker to obtain a blue photosensitive resin composition.

### Assays

The photosensitive resin composition was spin-coated on a glass substrate (100 mm×100 mm), dried under a pressure of 100 mmHg for 30 seconds, and was pre-baked at a temperature of 80° C. for 2 minutes to form a pre-baked film having a thickness of 2.5 μm. The pre-baked film was exposed using a mask aligner (Canon PLA-501F, 100 mJ/cm²), was immersed into a developer solution at a temperature of 23° C. for 1 minutes, was washed with water.

The composition was then post-baked at a temperature of 235° C. for 30 minutes. A photosensitive resin layer having a thickness of about 2.0 μm was obtained thereby on the glass substrate.

(a) Contrast

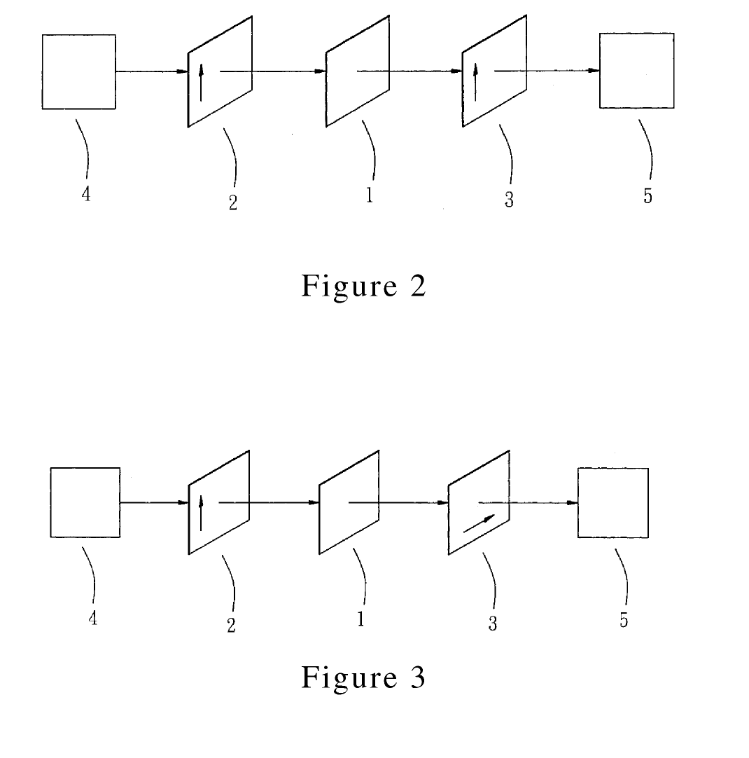

The contrast of the resulting photosensitive resin layer was measured by the luminance determined with the method shown in FIGS. 2 and 3. The resulting photosensitive resin layer 1 was placed between two polarizing plates 2 and 3. The light emitting from a light source 4 irradiates sequentially through the polarizing plate 2, the photosensitive resin layer 1, and finally through the polarizing plate 3. The luminance (cd/cm²) of the light through the polarizing plate 3 was measured by a luminance meter 5 (manufactured by Topcon Corporation, Japan, model BM-5A).

As shown in FIG. 2, when the polarization direction of the polarizing plate 3 was parallel to that of the polarizing plate 2, the measured luminance was A (cd/cm²). Further, as shown in FIG. 3, when the polarization direction of the polarizing plate 3 was vertical to that of the polarizing plate 2, the measured luminance was B (cd/cm²). The contrast can be obtained by the ratio of luminance A/luminance B. The criteria are as follows.
∘: (luminance A/luminance B)≧3500
Δ: 3000≦luminance A/luminance B)<3500
: (luminance A/luminance B)<3000

(b) Smoothness of the Edge Profile

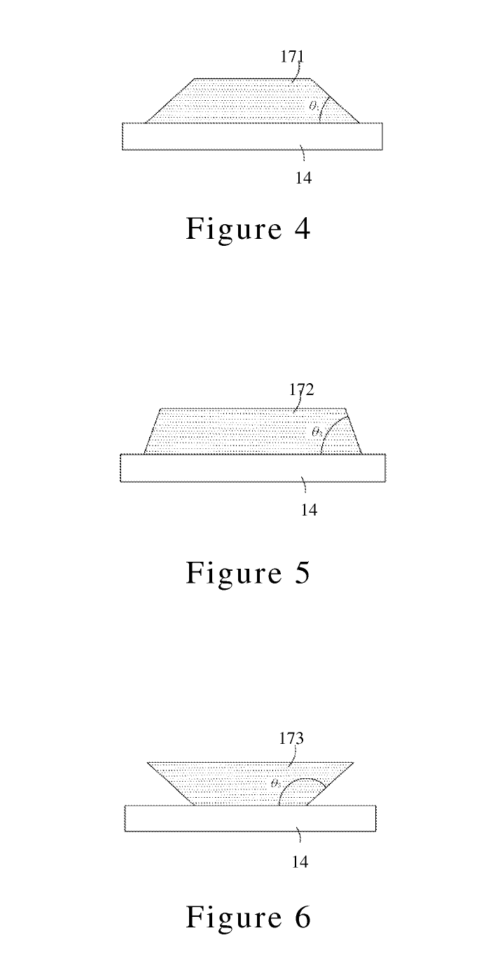

The smoothness was measured according to the shape of the edge profile of the resulting photosensitive resin layer with the scanning electron microscope (SEM).
∘: as shown in FIG. 4, the edge angle of the photosensitive resin layer 171 (corresponding to the sidewall angle of the substrate 14) is 10°<θ1≦60°.
Δ: as shown in FIG. 5, the edge angle of the photosensitive resin layer 172 (corresponding to the sidewall angle of the substrate 14) is 60°<θ2≦9°.
: as shown in FIG. 6, the edge angle of the photosensitive resin layer 173 (corresponding to the sidewall angle of the substrate 14) is θ3>90°.

(c) Color Difference After Post-Baking

The photosensitive resin composition was spin-coated on a glass substrate (100 mm×100 mm), dried under a pressure of 100 mmHg for 30 seconds, and was pre-baked at a temperature of 80° C. for 2 minutes to form a pre-baked film having a thickness of 2.5 μm. The pre-baked film was exposed using a mask aligner (Canon PLA-501F, 100 mJ/cm²), was immersed into a developer solution at a temperature of 23° C. for 1 minutes, was washed with water. The chromaticity (L*, a*, b*) was measured by the chromometer (Otsuka Electronics Co., Ltd., Model MCPD).

The composition was then post-baked at a temperature of 235° C. for 30 minutes. A photosensitive resin layer having a thickness of about 2.0 μm was obtained thereby on the glass substrate. The chromaticity was measured again. The difference of the chromaticity (ΔEab*) was measured as below:

ΔEab*={(ΔL)²+(Δa)²+(Δb)²}^{1/2}
∘: ΔEab*<3
Δ: 3≦ΔEab*<6
×: ΔEab*≧6

(d) Adhesion

According to the test JIS K5400 (1900)8.5, mesh test of 8.5.2, the coated layer after post-baking was cut by a knife to obtain a 100 mesh and then torn with tape. The number of torn meshes is counted and the criteria of the assay are shown blow:
∘: below 0
Δ: 0 to 10
×: more than 10

TABLE 3
Contents and Assays of Examples and Comparative Examples of the Photosensitive Resin Composition

| | | | Examples | | | | | | | Comparative Examples | | | | |
|---|---|---|---|---|---|---|---|---|---|---|---|---|---|---|
| Contents | | | 1 | 2 | 3 | 4 | 5 | 6 | 7 | 1 | 2 | 3 | 4 | 5 |
| alkali-soluble resin | A-1 | A-1-1 | 5 | | | | 90 | | | | | 5 | 5 | |
| (A) (parts by weight) | | A-1-2 | | 20 | | | | 100 | | | | | | |
| | | A-1-3 | | | 40 | | | | 100 | | | | | |
| | | A-1-4 | | | | 70 | | | | | | | | |
| | A-2 | A-2-1 | 95 | | | | | | | 100 | | 95 | 95 | 100 |
| | | A-2-2 | | 80 | | | 10 | | | | 100 | | | |
| | | A-2-3 | | | 60 | | | | | | | | | |
| | | A-2-4 | | | | 30 | | | | | | | | |
| compound having an | B-1 | | 120 | 120 | 150 | 150 | 200 | 100 | 100 | 120 | 120 | 120 | 120 | 120 |
| ethylenically | B-2 | | | | | | | 20 | 50 | | | | | |
| unsaturated group | | | | | | | | | | | | | | |
| (B)(parts by weight) | | | | | | | | | | | | | | |
| photoinitiator | C-1 | | 40 | 40 | 50 | 50 | | 50 | 50 | 40 | 40 | 40 | 40 | 40 |
| (C)(parts by weight) | C-2 | | | | | | 60 | 10 | | | | | | |
| | C-3 | | | 10 | | 20 | | 10 | 10 | | 10 | | | |
| organic solvent | D-1 | | 2000 | 2500 | 3000 | | | 1000 | 1500 | 2000 | 2500 | 2000 | 2000 | 2000 |
| (D)(parts by weight) | D-2 | | | | | 2000 | | 1000 | 500 | | | | | |
| | D-3 | | | | | | 2000 | | | | | | | |
| pigment | E-1 | E-1-1 | 190 | | | 90 | | 220 | | 190 | | | 200 | 200 |
| (E)(parts by weight) | blue | E-1-2 | | 180 | | | 75 | | 130 | | 180 | | | |
| | pigment | E-1-3 | | | 120 | | | | | | | | | |
| | E-2 | E-2-1 | | | | | | 28 | | | | | | |
| | violet | E-2-2 | | | | | | | 17 | | | | | |
| | pigment | | | | | | | | | | | | | |

| dye | F-1 | 10 | | | | | 2 | | 10 | | 200 | | |
|---|---|---|---|---|---|---|---|---|---|---|---|---|---|
| (F)(parts by weight) | F-2 | | 20 | | 60 | 75 | | 3 | | 20 | | | |
| | F-3 | | | 30 | | | | | | | | | |
| pigment(E)/dye(F)(wt %/wt %) | | 95/5 | 90/10 | 80/20 | 60/40 | 50/50 | 99.2/0.8 | 98/2 | 95/5 | 90/10 | 0/100 | 100/0 | 100/0 |
| Assay | contrast | ∘ | ∘ | ∘ | ∘ | ∘ | ∘ | ∘ | | | ∘ | | |
| | Smoothness of | ∘ | ∘ | ∘ | ∘ | ∘ | ∘ | ∘ | ∘ | ∘ | ∘ | | |
| | edge profile | | | | | | | | | | | | |
| | Color Difference | ∘ | ∘ | ∘ | ∘ | ∘ | ∘ | ∘ | Δ | Δ | | ∘ | Δ |
| | After Post-Baking | | | | | | | | | | | | |
| | adhesion | ∘ | ∘ | ∘ | ∘ | ∘ | ∘ | ∘ | | | ∘ | Δ | |

B-1 DPHA Dipentaerythritol hexaacrylate
B-2 DPTMA Dipentaerythritol tetra(meth)acrylate
C-1 Irgacure 369 2-benzyl-2-N,N-dimethylamino-1-(4-morpholinophenyl)-1-butanone
C-1 Irgacure 907 2-methyl-1-(4-methylthiophenyl)-2-morpholino-1-propanone
C-3 EABF 4,4′-bis(diethylamino)benzophenone
D-1 PGMEA Propylene glycol methyl ether acetate
D-2 EEP Ethyl 3-ethoxypropionate
D-3 CHE Cyclohexanone
E-1-1 C.I. B15: 4
E-1-2 C.I. B15: 6
E-1-3 C.I. B21
E-2-1 C.I. V23
E-2-2 C.I. V29
F-1 C.I. Solvent R24
F-2 C.I. Solvent R49
F-3 C.I. Acid R289

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A photosensitive resin composition comprising:
an alkali-soluble resin (A);
a compound having an ethylenically unsaturated group (B);
a photoinitiator (C);
an organic solvent (D);
a pigment (E); and
a dye (F);
wherein the alkali-soluble resin (A) comprises a polysiloxane (A-1), and the polysiloxane (A-1) is obtained by hydrolyzing and condensing a silane compound represented by Formula (1);
Si(R^{a})_{z}(OR^{b})_{4-z} Formula (1)
wherein:
at least one of R^{a} represents an alkyl group having a carboxylic acid anhydride substituent; and the other R^{a} is independently selected from the group consisting of a hydrogen atom, a C₁-C₁₀ alkyl group, a C₂-C₁₀ alkenyl group, and a C₆-C₁₅ aryl group;
R^{b} is independently selected from the group consisting of a hydrogen atom, a C₁-C₆ alkyl group, a C₁-C₆ acyl group, and a C₆-C₁₅ aryl group; and
z represents an integer from 1 to 3.

2. The photosensitive resin composition according to claim 1, wherein the amount of the polysiloxane (A-1) used is from 5 to 70 parts by weight based on 100 parts by weight of the alkali-soluble resin (A) used.

3. The photosensitive resin composition according to claim 1, wherein the alkali-soluble resin (A) further comprises an acrylic resin (A-2).

4. The photosensitive resin composition according to claim 1, wherein the amount of the acrylic resin (A-2) used is from 30 to 95 parts by weight based on 100 parts by weight of the alkali-soluble resin (A) used.

5. The photosensitive resin composition according to claim 1, wherein the amount of the compound having an ethylenically unsaturated group (B) used is from 10 to 500 parts by weight; the amount of the photoinitiator (C) used is from 2 to 200 parts by weight; the amount of the organic solvent (D) used is from 500 to 5,000 parts by weight; and the total amount of the pigment (E) and the dye (F) used is from 100 to 800 parts by weight based on 100 parts by weight of the alkali-soluble resin (A) used.

6. The photosensitive resin composition according to claim 1, wherein the pigment (E) comprises a blue pigment (E-1).

7. The photosensitive resin composition according to claim 1, wherein the pigment (E) comprises a violet pigment (E-2).

8. The photosensitive resin composition according to claim 1, wherein the dye (F) comprises a red dye.

9. The photosensitive resin composition according to claim 1, wherein the amount of the pigment (E) used is from 50 to 99.5 wt %; and the amount of the dye (F) used is from 0.5 to 50 wt % based on 100 wt % of the total amount of the pigment (E) and the dye (F) used.

10. A method for manufacturing a color filter comprising forming a pattern with the photosensitive resin composition according to claim 1.

11. The method according to claim 10, wherein the amount of the polysiloxane (A-1) used is from 5 to 70 parts by weight based on 100 parts by weight of the alkali-soluble resin (A) used.

12. The method according to claim 10, wherein the alkali-soluble resin (A) further comprises an acrylic resin (A-2).

13. The method according to claim 10, wherein the amount of the acrylic resin (A-2) used is from 30 to 95 parts by weight based on 100 parts by weight of the alkali-soluble resin (A) used.

14. The method according to claim 10, wherein the amount of the compound having an ethylenically unsaturated group (B) used is from 10 to 500 parts by weight; the amount of the photoinitiator (C) used is from 2 to 200 parts by weight; the amount of the organic solvent (D) used is from 500 to 5,000 parts by weight; and the total amount of the pigment (E) and the dye (F) used is from 100 to 800 parts by weight based on 100 parts by weight of the alkali-soluble resin (A) used.

15. The method according to claim 10, wherein the pigment (E) comprises a blue pigment (E-1).

16. The method according to claim 10, wherein the pigment (E) comprises a violet pigment (E-2).

17. The method according to claim 10, wherein the dye (F) comprises a red dye.

18. The method according to claim 10, wherein the amount of the pigment (E) used is from 50 to 99.5 wt %; and the amount of the dye (F) used is from 0.5 to 50 wt % based on 100 wt % of the total amount of the pigment (E) and the dye (F) used.

19. A color filter manufactured by the method according to Claim 10.

20. A liquid crystal display device comprising the color filter according to claim 19.
